(19) United States
(12) Patent Application Publication
(10) Pub. No.: US 2006/0274934 A1
(43) Pub. Date: Dec. 7, 2006

(54) Apparatus and method for improving measuring accuracy in the determination of structural data

(75) Inventors: Hans-Artur Boesser, Breidenbach (DE); Michael Heiden, Woelfersheim (DE); Walter Steinberg, Weilmuenster-Moettau (DE)

Correspondence Address: HOUSTON ELISEEVA, 4 MILITIA DRIVE, SUITE 4, LEXINGTON, MA, 02421, US

(73) Assignee: Vistec Semiconductor Systems GmbH, Wetzlar (DE)

(21) Appl. No.: 11/405,937

(22) Filed: Apr. 18, 2006

(30) Foreign Application Priority Data
Jun. 3, 2005 (DE) DE 102005025535.3

(51) Int. Cl. G06K 9/00

(52) U.S. Cl. 382/151

(57) ABSTRACT

A method and an apparatus are disclosed, whereby an improvement of the measuring accuracy in the determination of structural data is facilitated. A first detector unit (15a) is provided for receiving the light reflected or transmitted by structures applied on the microscopic component (2). A second detector (15b) is provided for detecting the illumination intensity emitted by the at least one light source, and a computer (18) for determining the structural data from the light received by the first detector unit (15a) and the second detector (15).

### RELATED APPLICATIONS

This application claims priority to German application serial number DE 10 2005 025 535.3 on Jun. 3, 2005, which is incorporated herein by reference in its entirety.

### FIELD OF THE INVENTION

The present invention relates to an apparatus for improving the measuring accuracy when determining structural data.

The present invention also relates to a method of improving the measuring accuracy when determining structural data.

### BACKGROUND OF THE INVENTION

Measuring structural dimensions (CD Critical Dimension) is carried out with the well-known systems, such as microscopes, CD-SEM, AFM etc. So called scatterometry methods are also based on measuring methods using microscopes, but they usually need repetitive structures in the measuring field.

Basically two different samples can be distinguished on which the measurement can be carried out. On the one hand they can be masks (quartz disks) and on the other hand wafers (silicon disks). The structures on the wafers are usually smaller by a factor of 4 than those on the masks. The dimensions given in the following relate to masks.

The measuring structures usually have a rectangular structure (e.g. single line, line fields (line and space, L&S)) with uniform, equidistant, and irregular distances, characterized by great lengths (several micrometers) and small widths (several hundreds of nanometers). Angles and so-called dots and holes (D&H), also referred to as contact holes, are also measured, which are only several hundreds of nanometers in both dimensions. A principle drawback of measuring using optical systems is the limitation in resolution due to diffraction phenomena. This leads, for example, to single lines becoming substantially widened or ceasing to be distinguishable from neighboring structures.

The measuring profiles recorded for determining the structural dimensions are also subject to strong fluctuations which are due to differences in the measuring structure associated with the various imaging methods (incident light (reflection) and transmitted light (transmission)), and to the various measuring samples themselves (phase-shift masks for various exposure wavelengths (193 nm with argon fluoride lasers (ArF)), 248 nm with krypton fluoride lasers (KrF)), chromium on quartz masks (CoG), or resist masks).

A stable method with very good measuring repeatability has been found in the method of edge detection in determining the CD, since it is relatively unaffected by small intensity fluctuations of illumination. Edge detection is based on the determination of a 100% level of the measured profile and the position of the two profile edges. This has been disclosed, for example, in DE 100 47 211.

In the absence of sufficient calibration standards, the readings are not sufficiently precise as absolute readings. The calibration is usually carried out by means of a so-called pitch structure, which defines a line and a space of an equidistant line array. The width of the pitch structure currently used is in the range of 1-4 micrometers. A pitch structure can be measured with high reproducibility since the same edges are used for determining the pitch (width).

By improving the resolution (higher aperture) or the optics and illumination, and the measuring stability it has been possible to achieve very good reproducibility (e.g. in the range of less than 1 nm with a DUV optics (deep ultraviolet (248 nm)), and also to shift the linearity limit to smaller structures. The DUV optics has been disclosed in DE 199 31 949. A DUV capable dry lens assembly for microscopes consists of lens groups of quartz glass, calcium fluoride and sometimes also lithium fluoride. It has a DUV focus for a wavelength band λ_{DUV}±Δλ, with Δλ=8 nm, and additionally a parfocal IR focus for an IR wavelength λ_{IR}, at 760 nm≦λ_{IR}<920 nm. To achieve this the element before the last has a concave form on both sides and its external radius on the side of the object is substantially smaller than its external radius on the side of the image. The DUV lens assembly is IR autofocus capable. Prior art methods of linearity improvements or optical proximity correction have been described in patent applications WO 01/92818 and DE 102 57 323. It relates to a method and a microscope for detecting images of an object, in particular, for determining the location of an object relative to a reference point, wherein the object is illuminated with a light source and imaged with the aid of an imaging system onto a detector, which is preferably a CCD camera. The detected image of the object is compared to a reference image, whereby information about the characteristics of the imaging system is taken into account to minimize the errors in the measuring value interpretation in the generation of the reference image. Moreover, if the images to be compared deviate from each other by a predetermined amount, the reference image is varied in such a way that it corresponds to the detected image at least to a substantial extent.

### SUMMARY OF THE INVENTION

It is therefore an object of the present invention to provide an apparatus with the aid of which an improvement in the enhancement of the linearity and therefore the precision of the measurement of structures close to the resolution limit is achieved.

This object is achieved with an apparatus for improving the measuring accuracy in the determination of structural data, comprising a support stage able to be moved in the X- and Y- coordinate directions, an additional holder is provided on the support stage to hold a microscopic component, at least one light source, at least one lens and a first detector unit for receiving the light reflected or transmitted by the structures applied to the microscopic component, a second detector for detecting the illumination intensity emitted by the at least one light source and a computer which derives the structural data from the light received by the first detector unit and the second detector unit.

It is also an object of the present invention to provide a method of determining dimensional measuring values (e.g. structural widths) with the aid of an optical system, wherein the improvement is in the enhancement of the linearity and therefore the precision of the measurement of structures close to the resolution limit.

This object is achieved with a method for improving the measuring accuracy in the determination of structural data, comprising the steps of:

determining at least one value of a structure to be measured on a microscopic component, wherein the value is determined by means of an edge detection method;

determining a value of the structure to be measured from the overall signal intensity of the structure and/or from a classification of the structure according to structural form, and/or from a classification of the surroundings, and/or from a deconvolution of overlying signal intensities,

determining and controlling a signal magnitude of the illumination intensity,

calculating a correction value from the classification data,

determining a theoretical correction factor resulting from the system data and the optics used and from the values of the obtained structural data; and

calculating the measuring value from all data.

This is advantageous because of the improved competitiveness with respect to non-optical systems. Further advantages and improvements result from the extended utilization of present measuring data and from the extension of the method for determining structural geometries by means of edge algorithms.

The apparatus for improving measuring accuracy in the determination of structural data is provided with a support stage able to be traversed in the X and Y coordinate directions. An additional holder for holding a microscopic component is supported on the support stage. At least one light source and at least one lens and one first detection unit is provided for receiving the light reflected or transmitted by the structures applied on the microscopic component. A second detector is provided which simultaneously records the illumination intensity of the at least one light source and feeds it to a computer which determines the structural data from the light received by the first detector unit and the second detector.

Measuring the non-critical structures is carried out in the same way. The measuring profiles of the non-critical structures are stored in memory, parameterized and used as a reference in the evaluation of the critical structures. The non-critical structures can be either on a predefined location on the holder, a reference sample or on the measuring sample itself. The measurement of the non-critical structures can be carried out after a certain amount of time.

The holder for the microscopic component supports a plurality of reference samples which can be attached to the holder in a fixed or releasable manner. The microscopic component can be a wafer or a mask.

The method of improving the measuring accuracy when determining structural data comprises the following steps:

determining at least one value of a structure to be measured on a microscopic component, wherein the value is determined by the edge detection method of the structure,

determining a value of the structure to be measured from a signal intensity of the edge detection and/or from a classification of the structure according to the structural form, and/or from a classification of the environment, and/or from a deconvolution of overlapping signal intensities, also referred to as surface detection in the following,

determining and controlling a signal strength of the illumination intensity,

computing a correction value from the classification data,

determining a theoretical correction factor derived from the system data and the optics used and from the values of the obtained structural data, and

calculating the measuring value from all data.

Classification of the structure is carried out according to the structure of the signal waveform and measured on the first detector unit, wherein the signal waveform can be a symmetrical curve or a rectangle or a rectangle with side peaks or an asymmetrical curve. In the classification of the environment the following features are taken into account: a bright or dark line, an OPC structural form or a square structure or a circular structure, an array of similar structures, an average distance to neighboring structures, or the overall brightness in the image.

The computation of the measuring value is done by recursion. When determining the measuring value a combination of the analyses from incident and transmitted-light measurements can be used.

In particular the determination and control of the 100% signal strength and the illumination intensity is used to determine a value typical for the structure from the signal profile, considering and incorporating all measuring parameters.

Further advantageous embodiments of the invention can be derived from the dependent claims.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The subject matter of the present invention is schematically shown in the drawing and will be described in the following with reference to the figures, wherein:

FIG. 1 shows a schematic view of a structure with which the CD measurements can be carried out;

FIG. 2 shows a schematic view of a sample holder used in the present structure;

FIG. 3 shows the measurement of single lines of varying CD of a CoG mask with a lens having an aperture of 0.9 and working in the visual spectrum;

FIG. 4 shows the measuring data of single lines and L&S structures of various CDs of an ArF mask (200×W1: lenses having an aperture of 1.20 (water immersion) at 248 nm; 150×: aperture of 0.9, also at 248 nm;

FIG. 5 shows profiles of single lines of a chrome-on-quartz mask with an uncorrected offset;

FIG. 6 shows profiles of single lines of a phase-shift mask with corrected offset;

FIG. 7 shows incident and transmitted-light profiles of a 300 nm L&S structure on a CoG mask;

FIG. 8 shows the comparison of obtained CD measuring values, wherein the evaluated values are normalized to the nominal value of 500 nm;

FIG. 9 shows a view according to FIG. 7, wherein the measured incident-light profile is inverted and the aperture of the condenser is 0.6;

FIG. 10 shows profiles of a 1100 nm structure, imaged with an I-line lens in incident and transmitted light and with an inverted AL profile; and

FIG. 11 shows measuring values for incident and transmitted light, normalized to 1.

### DETAILED DESCRIPTION OF THE PREFERRED EMBODIMENTS

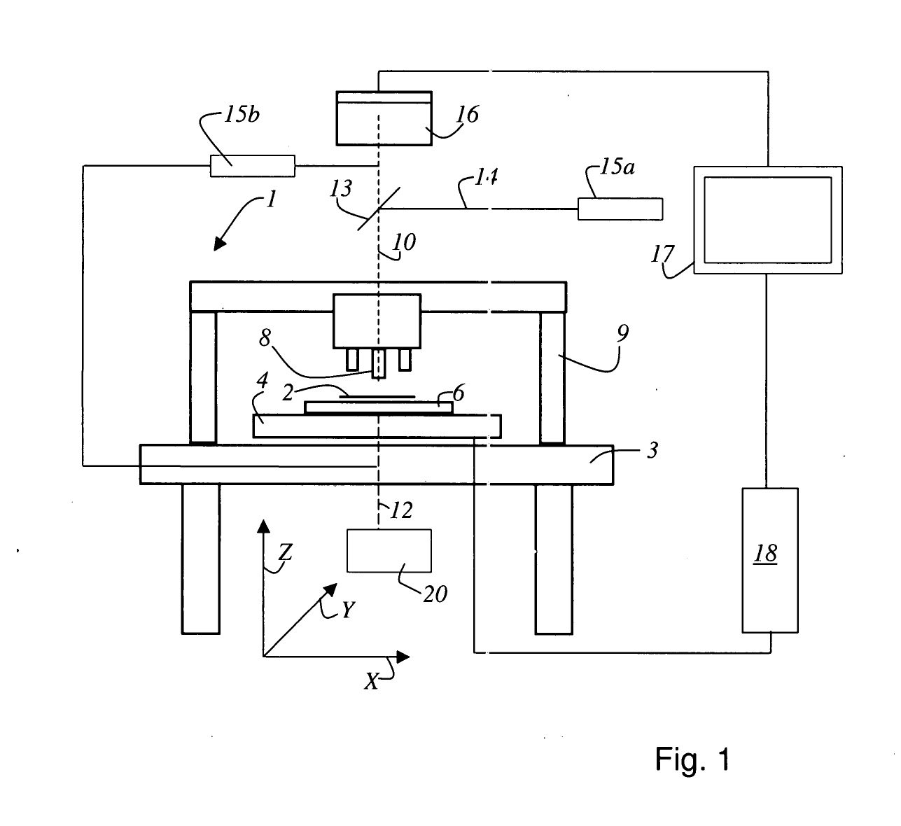

FIG. 1 shows the structure 1, with which CD measurements can be carried out on a microscopic component 2. The support stage 4 for the microscopic components 2 is provided on a base 3. The support stage 4 is configured as a scanning stage. The support stage 4 can be traversed in the X and Y coordinate directions. The microscopic component 2 to be inspected is placed on support stage 4. The microscopic component 2 can be held on the support stage 4 by an additional holder 6. Microscopic component 2 is a wafer, a mask, a micromechanic component or a related component. For imaging the microscopic component 2, at least lens assembly (objective) 8 is provided which defines an imaging beam path 10. Support stage 4 and additional holder 6 are configured in such a way that they are also suitable for transmitted-light illumination. For this purpose support stage 4 and additional holder 6 have a recess (not shown) for letting the transmitted-light illumination 12 pass. The transmitted-light illumination 12 is emitted by a light source 20. The incident-light illumination is emitted by a light source 16. In the imaging beam path 10, a beam splitter 13 is provided, which directs the detection light 14 into a first detection unit 15a. The first detection unit 15a is provided downstream of the beam splitter 13 in the imaging beam path 10. A CCD camera can also be provided, with which the image of the location of the microscopic component 2 to be inspected is recorded or taken. Detection unit 15a is linked to a display 17 and a computer 18. Computer 18 is for controlling apparatus 1, for processing the data obtained and for storing and evaluating the obtained data. An extension of the structure of the apparatus shown in FIG. 1 involves a second detector 15b being provided, which is used for the simultaneous recording of the illumination intensity. Well-known optical means are provided to direct light in a corresponding way to the second detector 15b. Non-critical reference structures are recorded in the same way simultaneously or later, preferably for example using a CCD camera.

In the present exemplary embodiment the plurality of lens assemblies (objectives) 8 are provided in a lens turret (not shown), so that a user can select different magnifications. The support stage 4 is configured in such a way that it can be traversed in the X and Y coordinate directions, which are orthogonal to each other. Thus each location of the microscopic component 2 to be inspected can be brought into the imaging beam path 10.

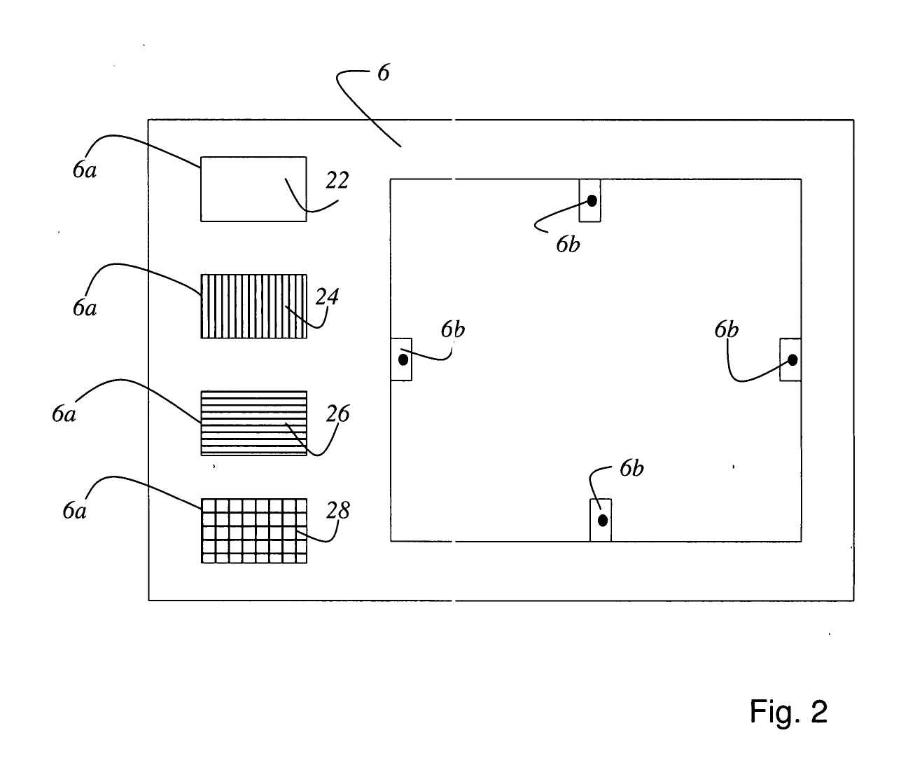

FIG. 2 shows a possible extension of the structure of the holder 6. Holder 6 comprises fixtures 6a for a (fixed) or a plurality of reference samples with suitable structures (pitch calibration, line calibration, intensity calibration). The reference samples 22, 24, 26 and 28 are provided with suitable structures for line calibration or intensity calibration. Holder 6 also includes holding elements 6b for the microscopic component.

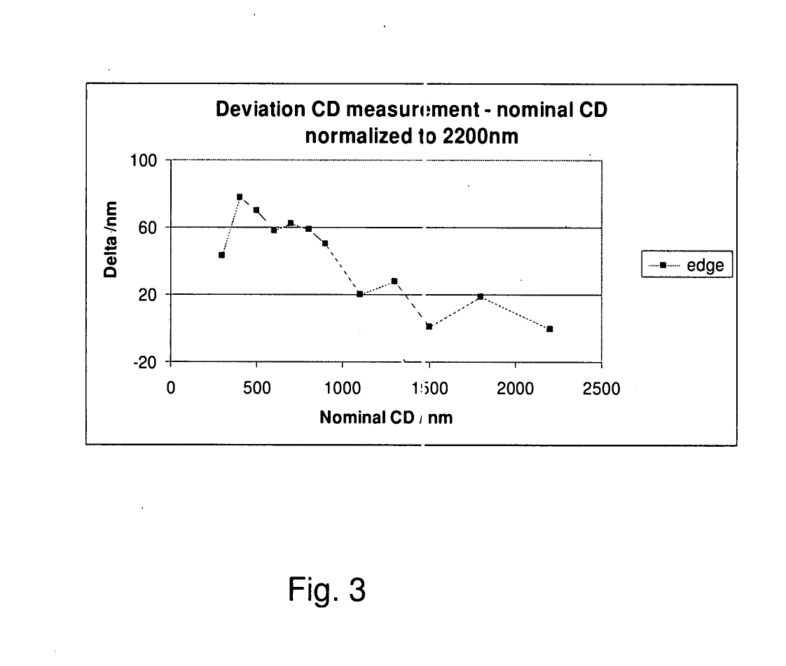

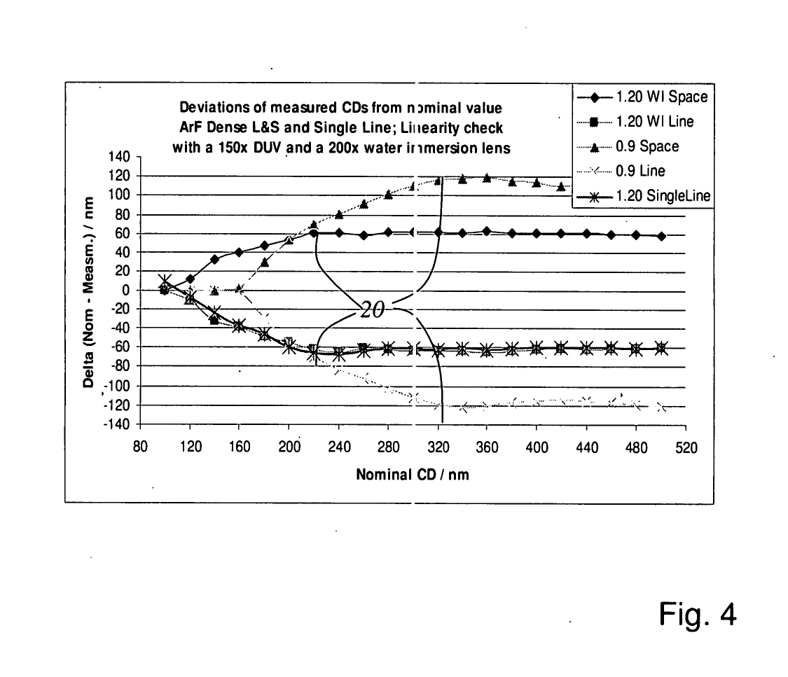

FIG. 3 shows the measurement of individual lines of different CDs of a CoG mask with a lens working in the visual spectral range having an aperture of 0.9 and a wavelength of 546 nm. If the difference of the measured and the nominal line width is plotted against the nominal values, there are strong deviations from the linearity in the range of the diffraction limit (see FIGS. 3 and 4). FIG. 4 shows the measurement of individual lines and L&S structures of different CDs on an ArF mask. For some of the present measurements a water immersion lens with a 200-fold magnification and an aperture of 1.20 was used. Other measurements were carried out with a lens having a 150-fold magnification and an aperture of 0.9. Both in measuring with the water immersion lens and in measuring with the lens having a 150-fold magnification, light having a wavelength of 248 nm is used. The linearity limit 20 is reached at about 320 nm in the measurement with the lens having a 150-fold magnification and an aperture of 0.9 with a nominal CD. This is true both for lines, called line in the following, and for spaces between the structures called space in the following. The linearity limit is reached at about 220 nm in measurements with the lens having 200-fold magnification and an aperture of 1.20 at a nominal CD. This is true for lines, for the spaces between the structures, and for an individual line (single line). Due to the improvement with respect to the resolution (higher aperture) of the optics and the illumination, and the measuring stability, it is possible to achieve very high repeatabilities (e.g. in the range of smaller than 1 nm using a DUV optics), and to shift the linearity limit towards smaller structures. In the process the linearity limit defines the value at which nominal CD the measured values can no longer be linearly corrected.

As already mentioned with respect to FIG. 1, the apparatus is provided with an additional detector which is suitable for simultaneous detection of illumination intensity. This detector is useful for recording fluctuations in the light intensity and to facilitate the comparison of measurement and reference data recorded at different times. This is necessary since a precise determination of the 100% level has to be carried out. The 100% level is the maximum or mean maximum light intensity observed after interaction with the sample by a detector. It varies with the light intensity supplied by the light source. The dark signal, i.e. 0% level, which is composed of the scattered light or, to a small degree, light transmitted by the otherwise absorbing structure (phase shift) and detector noise is also determined from the measuring data.

When the structural width is determined via edge detection, the width is determined at a predetermined percentage, e.g. 50%, of the 100% level. This is why the 100% value is, of course, extremely important. The importance is not so pronounced in the determination of edge positions for defining the center of mass of a structure, as it is carried out in the coordinate measurements (registration). Even though the 100% level varies, the center of mass remains fixed, since both edges are displaced.

In surface detection, the determination of the width is carried out in the first order above the comparison of overall intensities. This comparison can supply, of course, the correct results only if the illumination remains constant, or changes in the illumination are detected simultaneously and independently of the structures to be measured.

The constancy of the light intensity of the illumination is a first order function of the constancy of the light source. It can be influenced both by long-term drift (burning out of the lamp) and by short-term fluctuations (supply voltage, magnetic field fluctuations in arc lamps, arc migration). In contrast to conventional structures, it must therefore be ensured that the intensity of the incoming light is detected in parallel or simultaneously with the measuring profile by the second detector 15b.

The measuring samples often have an anti-reflection coating not specified by the manufacturers in any great detail. It influences the 100% level. Differences in reflection and transmission of the measuring wavelength can also arise due to structural preconditions (varying thicknesses of the individual layers; for example phase layer masks have at least two layers).

Another advantage of using reference structures is in improved tool-to-tool matching (golden sample). Tool-to-tool matching describes how the measurement of identical structures can differ in the same measuring systems. Again, holder 6 shown in FIG. 2 is provided with a plurality of reference structures which can then be used for the measurement.

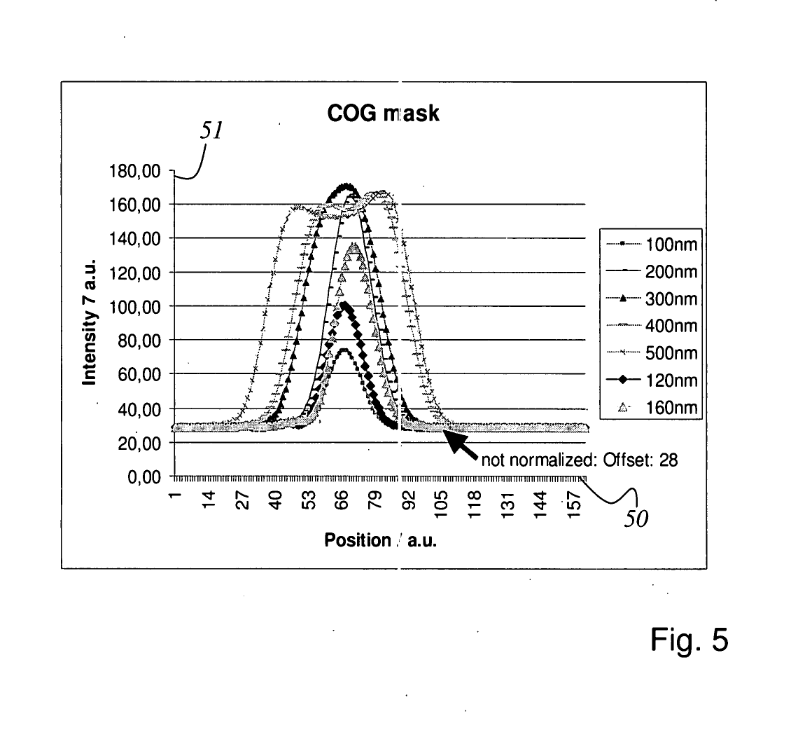

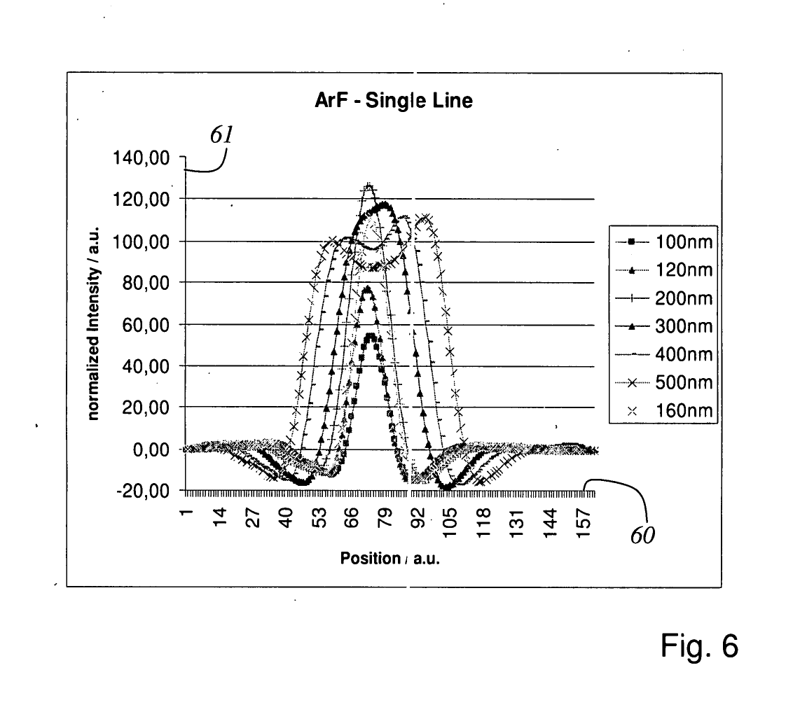

The form of the profile is determined by the optics, the macroscopic and the microscopic structure of the measuring sample and the measuring detector. However, the form is similar across a wide range of structural widths so that a classification can be carried out. The profiles in FIGS. 5 and 6 were imaged in the transmitted-light mode. Large intensity values therefore correspond to locations not covered with chromium or other absorbing materials. The detector detects the light intensity transmitted by the structure. The area surrounding the structure appears dark. The individual lines in the FIGS. 5 have different structural widths, such as 100 nm, 120 nm, 160 nm, 200 nm, 300 nm, 400 nm and 500 nm. As can be seen from the figure, differences in the signal waveform result as a function of the sample, and as a function of the structural width.

The abscissa 50 is the position of the structure in arbitrary units. The ordinate 51 is the measured intensity also in arbitrary units.

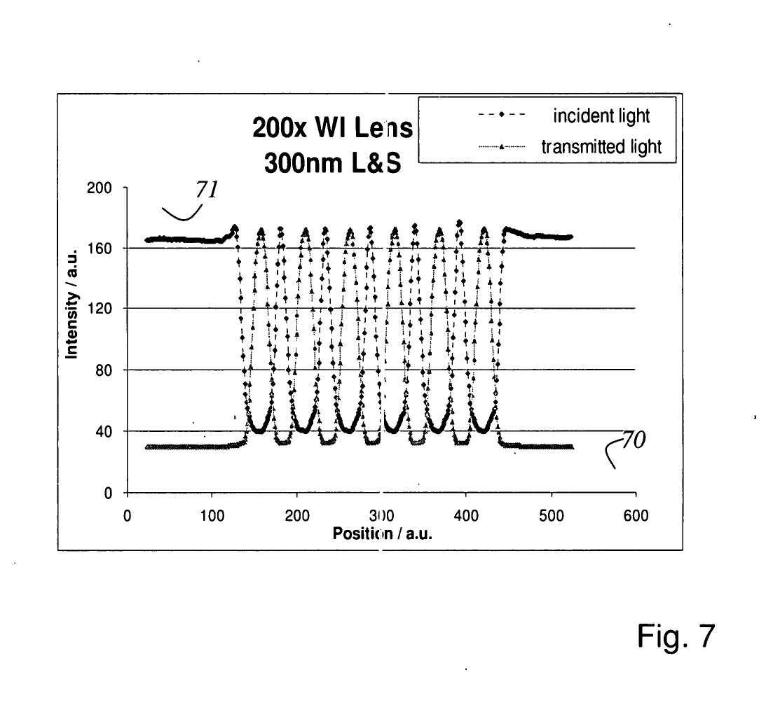

FIG. 6 shows the profiles of individual lines of a phase-shift mask with corrected offset. As in FIG. 5, individual lines were also measured in this case. The individual line is applied to an ArF mask. The individual lines had different structural widths, such as 100 nm, 120 nm, 160 nm, 200 nm, 300 nm, 400 nm and 500 nm. The abscissa 60 is the position of the structure in arbitrary units. The ordinate 61 is the measured and normalized intensity also in arbitrary units. The details of the profiles reflect both mask characteristics (strong overshoots with the ArF mask, not with the CoG mask) and optical characteristics (such as a condenser aperture which is too small, causes narrow spikes; generates differences in the profile form with measurements of the sample in the X or Y directions). The profiles shown in FIGS. 5 and 6 were obtained in transmitted-light measurements. The surroundings of the structures were dark. If the surroundings are bright, the profile forms are inverted in a similar way as shown in FIG. 7. The profiles shown there of an identical structure were obtained with transmitted light and incident light. Bright and dark surroundings also cause differences. FIG. 7 shows the measurement of a plurality of structures with spaces between them (L&S structure), which were imaged with incident light and transmitted light. A 300 nm L&S structure is applied to a CoG mask. The abscissa 70 is the position of the structure in arbitrary units. The ordinate 71 is the measured intensity also in arbitrary units. The lines imaged in transmitted light appear substantially narrower. FIG. 7 also shows that the profiles of the individual lines overlap. These profiles were deconvoluted and then supply more precise data for the edge and surface detection.

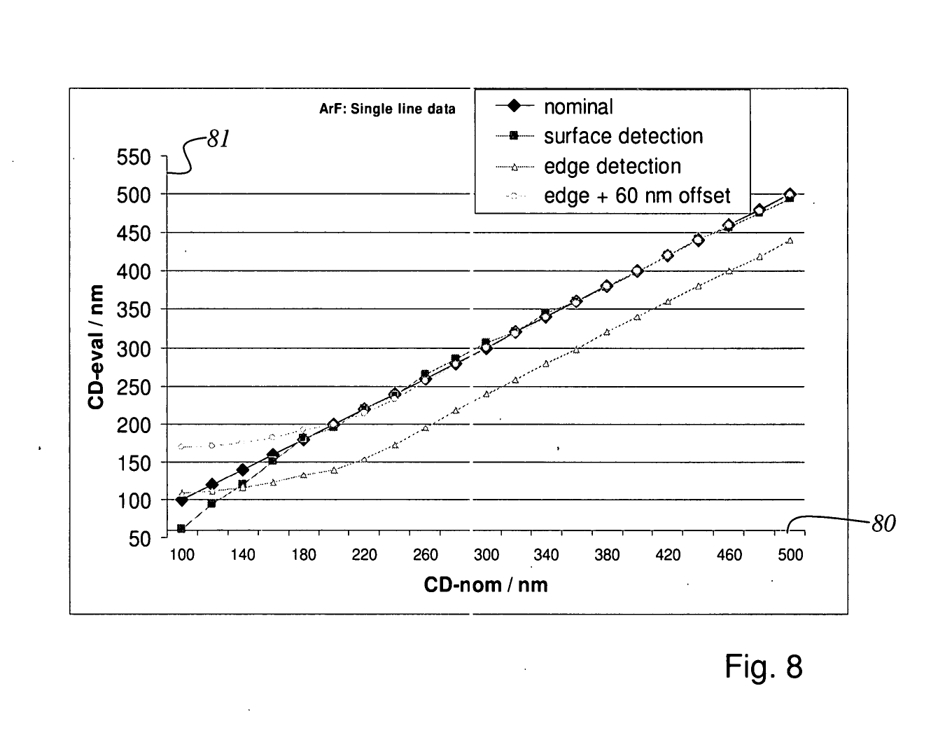

FIG. 8 shows the comparison of detected CD measuring values, wherein the evaluated values have been normalized to the 500 nm nominal value. If the intensity values for the individual profiles measured in FIG. 8 are added together and normalized to a reference profile, a value dependent on the structural width results. Herein it has to be obvious from the classification data in which positional area the addition is carried out. FIG. 8 shows the CD values determined with this method compared to the nominal values and the values determined with the edge detection. Each time one individual line on an ArF mask was measured. The abscissa 80 is the nominal CD in nanometers. The ordinate 81 is the calculated CD also in nm. The individual bent curves reflect the change in the linearity due to diffraction. The deviation of the data from the nominal values of the surface detection is smaller than that of the edge detection.

The data obtained from the surface and edge detection can be combined in the next step. Herein they have to be weighted to reflect the measuring accuracy and repeatability with which they have been detected. A possibility for correction (proximity correction) of the surface detection data derives from the assumption that as the structural widths (width˜wavelength) become smaller, light is lost by the fact that ever more diffraction orders are at an angle to the optical axis of the lens, which is larger than the acceptance range of the optics used, and are therefore no longer imaged in the detector plane. If the measuring structures are not isolated, the profiles in this structural width range have to be deconvoluted. This is possible at least by fitting the edges with semi-empirical functions.

Currently the most difficult problem is the calculation of the diffraction at the structure. As mentioned there are theoretical approaches which are, however, always very specific to the application. Sometimes they have interfering artifacts in the CD measurement, and the theoretical modeling is very time consuming. Moreover the measured wave fronts experience interference due to manufacturing faults of the optics (and the measuring sample) over the theory.

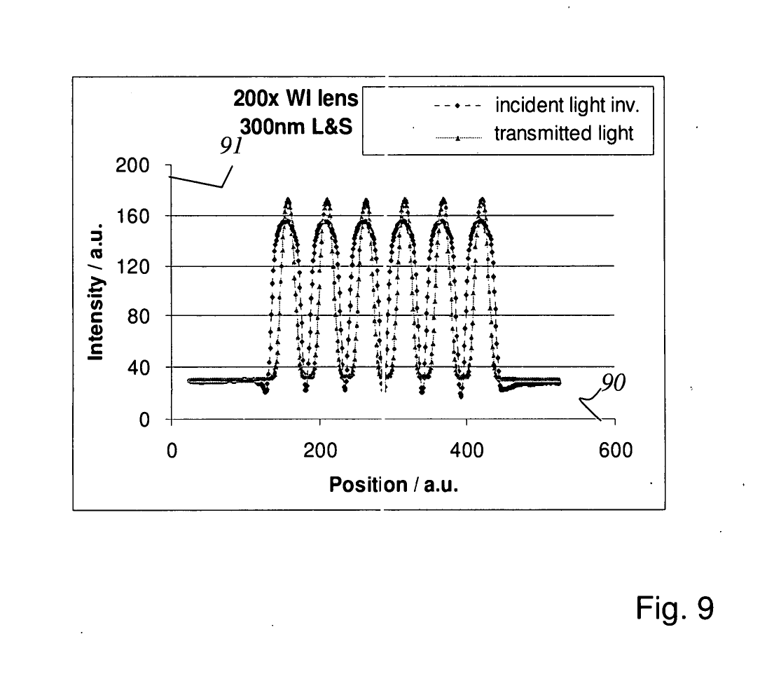

As shown in FIG. 7 the measuring transmission and reflection methods generate different profile forms. FIG. 9 is a view according to FIG. 7, wherein the measured incident-light profile is inverted and the aperture of the condenser is 0.6. The differences in the “measured” widths of the lines and spaces correspond to the differences for line and space measurements shown in FIG. 4. The abscissa 90 is the position of the structure in arbitrary units. The ordinate 91 is the measured intensity also in arbitrary units.

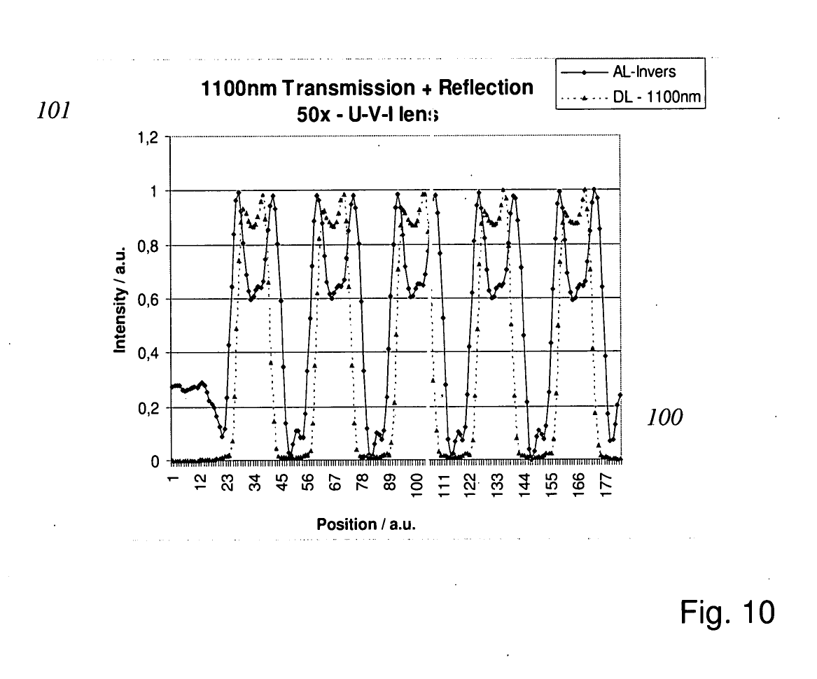

FIG. 10 shows the profiles of a 1 100 nm structure, imaged with an I-line lens in incident light and transmitted light and with an inverted incident-light profile. The abscissa 100 is the position of the structure in arbitrary units. The ordinate 101 is the measured intensity also in arbitrary units.

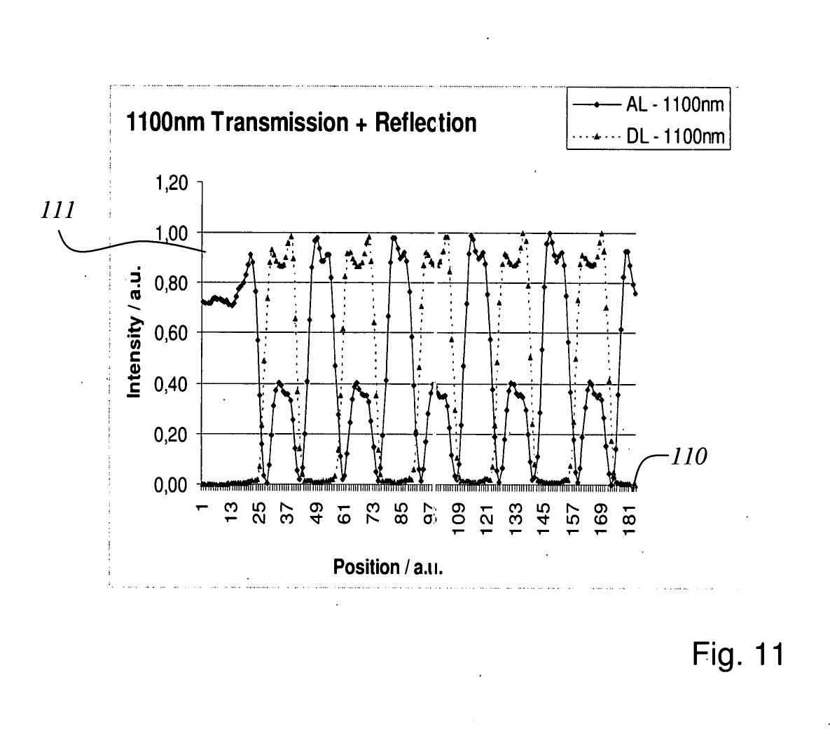

FIG. 11 shows measuring values for incident light and transmitted light normalized to 1. The abscissa 110 is the position of the structure in arbitrary units. The ordinate 111 is the measured intensity also in arbitrary units.

The two figures show part of the multitude of different structural forms.

While this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus for improving the measuring accuracy in the determination of structural data, comprising a support stage able to be moved in the X- and Y- coordinate directions, an additional holder is provided on the support stage to hold a microscopic component, at least one light source, at least one lens and a first detector unit for receiving the light reflected or transmitted by the structures applied to the microscopic component, a second detector for detecting the illumination intensity emitted by the at least one light source and a computer which derives the structural data from the light received by the first detector unit and the second detector unit.

2. The apparatus according to claim 1, wherein the first detector records the intensity of the light emitted by non-critical structures which is above the linearity limit, wherein the non-critical structures are provided in the area around the structure to be measured.

3. The apparatus according to claim 1 wherein the holder for the microscopic component supports a plurality of reference samples.

4. The apparatus according to claim 3, wherein the reference samples are fixedly attached to the holder.

5. The apparatus according to claim 3, wherein one of the reference samples is fixedly attached to the holder and in that the other reference samples are exchangeable.

6. The apparatus according to claim 3, wherein the reference samples are releasably attached to the holder.

7. The apparatus according to claim 3, wherein the reference samples are provided with suitable structures for line calibration or intensity calibration.

8. The apparatus according to claim 1, wherein the microscopic component is a wafer or a mask.

9. A method for improving the measuring accuracy in the determination of structural data, comprising the steps of:
determining at least one value of a structure to be measured on a microscopic component, wherein the value is determined by means of an edge detection method;
determining a value of the structure to be measured from the overall signal intensity of the structure and/or from a classification of the structure according to structural form, and/or from a classification of the surroundings, and/or from a deconvolution of overlying signal intensities,
determining and controlling a signal magnitude of the illumination intensity,
calculating a correction value from the classification data,
determining a theoretical correction factor resulting from the system data and the optics used and from the values of the obtained structural data; and
calculating the measuring value from all data.

10. The method according to claim 9, wherein the classification of the structure is carried out according to the structure of the signal waveform measured on the first detector unit, wherein the signal waveform can be a symmetrical curve, a rectangle, or a rectangle with side peaks, or an asymmetrical curve.

11. The method according to claim 9, wherein in the classification of the surroundings the following features are taken into account: a bright or dark line, an OPC structural form, a rectangular structure, a circular structure, an array of similar structures, an average distance to neighbouring structures, or the overall brightness in the image.

12. The method according to claim 9, wherein the calculation of the measuring value is carried out by means of recursion.

13. The method according to claim 9, wherein when determining the measuring value a combination of the analyses from incident-light and transmitted-light measurements are utilized.

14. The method according to claim 9, wherein in the determination of a value typical for the structure from the signal profile, taking all measuring parameters into account and using all measuring parameters, in particular the determination and control of the 100% signal magnitude and the illumination intensity are utilized.

15. The method according to claim 9, wherein a second detector is provided, with the aid of which the intensity of the light is detected, which is emitted by non-critical structures, which are above the linearity limit, wherein the non-critical structures are provided in the area around the structure to be measured.

16. The method according to claim 15, wherein said non-critical structures are reference samples or reference structures which are provided on the holder.
